(19) United States
(12) Patent Application Publication
(10) Pub. No.: US 2014/0243081 A1
(43) Pub. Date: Aug. 28, 2014

(54) METHOD AND APPARATUS FOR INTERACTIVE GAME WITH MUSIC-DERIVED VARIABLE PARAMETERS

(71) Applicant: SANDY FLIDERMAN, ALBERTSON, NY (US)

(72) Inventor: SANDY FLIDERMAN, ALBERTSON, NY (US)

(21) Appl. No.: 14/038,217

(22) Filed: Sep. 26, 2013

Related U.S. Application Data
(60) Provisional application No. 61/705,631, filed on Sep. 26, 2012.

(51) Int. Cl. A63F 13/00

(52) U.S. Cl. CPC A63F 13/00
USPC 463/31

(57) ABSTRACT

A game system for implementing a computer game on computers, tablets, smartphones, other mobile devices and/or consoles, the computer game having a round-based play system and a baseline set of rules. The game system comprises providing a user with access to a music library including a plurality of musical pieces, each musical piece including one or more music-derived parameters, prompting the user to select a specific one of the plurality of musical pieces, determining the value of the one or more music-derived parameters for the selected musical piece, modifying the baseline rules of the computer game based upon the determined values of the music-derived parameter and initiating a game round of the computer game using the modified baseline rules of the game and playing the selected music piece during the game round.

### CROSS-REFERENCE TO RELATED APPLICATIONS

This application claims benefit of U.S. Provisional Application No. 61/705,631, filed Sep. 26, 2012, entitled METHOD AND APPARATUS FOR INTERACTIVE GAME WITH MUSIC-DERIVED VARIABLE PARAMETERS (Atty. Dkt. No. VMZA-31461), the specification of which is incorporated herein by reference in its entirety.

### TECHNICAL FIELD

The following disclosure relates to interactive computer games, software for interactive computer games and methods and apparatus for implementing interactive computer games on computers, tablets, smartphones, mobile devices and game consoles. In particular, it relates to interactive computer games, software for interactive computer games and methods and apparatus for implementing interactive computer games that utilize music-derived variable parameters as elements of game play and/or elements of the game experience perceived by the user.

### BACKGROUND

It is well known to incorporate music in interactive computer games, for example as a sound track, to indicated different game levels and/or as sound effects. In games of the action- or puzzle-genre, the music is often pre-programmed such that the user has no direct control over the music. In some cases, the music track may be “looped” or dynamically generated such that it has no pre-determined running time and can play continuously. In some games, the length of each game round (or level) may be determined by the player's performance, for example, the time needed to successfully complete the required challenges on a level (i.e., “beat the level”), or the time at which the player fails to complete the minimum number of challenges (i.e., “loses”). In other games, the length of the game round/level is set by the number of turns the player receives. In such games, the music generally plays for the duration of each game round and stops at the end of the round, whether the currently playing music track is completed or not.

It is also known to have interactive computer games of the music-simulation genre, e.g., Guitar Hero® or Rock Band®, in which the user may select music from a list and then manipulates a controller in response to the presentation of on-screen displays. The music tracks in such game may have a predetermined track running time. As long as the user provides a predetermined level of correct inputs, the music track continues to play. However, if the user's level of correct inputs fall below a predetermined level, the round is over and the music stops mid-track.

### SUMMARY

In one aspect, a game system is provided for implementing a computer game on computers, tablets, smartphones, other mobile devices and/or consoles, the computer game having a round-based play system and a baseline set of rules. The game system comprises providing a user with access to a music library including a plurality of musical pieces, each musical piece including one or more music-derived parameters, prompting the user to select a specific one of the plurality of musical pieces, determining the value of the one or more music-derived parameters for the selected musical piece, modifying the baseline rules of the computer game based upon the determined values of the music-derived parameter and initiating a game round of the computer game using the modified baseline rules of the game and playing the selected music piece during the game round.

In another aspect, a game system is provided for implementing a computer game on a computer, a tablet computer, a smartphone, another mobile device and/or a console having a processor, a display operatively connected to the processor, an audio speaker operatively connected to the processor, an input device operatively connected to the processor, a memory operatively connected to the processor and a communication device operatively connected to the processor. The computer game has a round-based play system and a baseline set of rules. The game system comprises providing, using a processor, a user with access to a music library in a memory operatively connected to the processor, the music library including a plurality of musical pieces, each musical piece including at least one music-derived parameter. The game system further comprises prompting, using a display operatively connected to the processor, the user to select a specific one of the plurality of musical pieces using an input device operatively connected to the processor. The game system further comprises determining, using the processor, a value of a first music-derived parameter for the selected musical piece. The game system further comprises; modifying, using the processor, a first baseline rule of a computer game in the memory, the modification being based upon the determined value of the first music-derived parameter. The game system further comprises initiating, using the processor, a game round of the computer game in the memory using the first modified baseline rule of the game and playing the selected music piece during the game round using an audio speaker operatively connected to the processor.

In one embodiment, the first baseline rule is a time duration value of a game round and the first music-derived parameter is a time duration value of the selected music piece.

In another embodiment, the first baseline rule is a brightness value of a game tile displayed on the display and the first music-derived parameter is a beat rate value of the selected music piece.

In yet another embodiment, the game system further comprises determining: using the processor, a value of a second music-derived parameter for the selected musical piece; modifying, using the processor, a second baseline rule of the computer game in the memory, the modification being based upon the determined value of the second music-derived parameter; and performing, using the processor, the game round of the computer game in the memory using the second modified baseline rule of the game.

In a still further embodiment, the second baseline rule is a brightness value of a game tile displayed on the display and the second music-derived parameter is an audio frequency value of the selected music piece.

In another embodiment, the second baseline rule is a brightness value of a game tile displayed on the display and the second music-derived parameter is an audio volume value of the selected music piece.

In yet another embodiment, the game system further comprises: downloading, using a communication device operatively connected to the processor, a music library from a remote location; and storing the music library in the memory.

### BRIEF DESCRIPTION OF THE DRAWINGS

For a more complete understanding, reference is now made to the following description taken in conjunction with the accompanying Drawings in which:

FIG. 1 shows the main menu screen of an interactive computer game having music-derived variable parameters implemented on a mobile device according to one embodiment of the invention;

FIG. 2 shows the store screen of the interactive computer game of FIG. 1;

FIG. 3 shows the settings menu screen of the interactive computer game of FIG. 1;

FIG. 4 shows the information menu screen of the interactive computer game of FIG. 1;

FIGS. 5, 6 and 7 show the top, middle and bottom, respectively, of the statistics screen of the interactive computer game of FIG. 1;

FIG. 8 shows the song selection screen of the interactive computer game of FIG. 1;

FIG. 9 shows the loading screen of the interactive computer game of FIG. 1;

FIG. 10 shows the countdown screen of the interactive computer game of FIG. 1;

FIG. 11 shows the main game play screen of the interactive computer game of FIG. 1 at the beginning of a game round;

FIG. 12 shows a subsequent view of the main game play screen of FIG. 11 during the same game round;

FIG. 13 shows a further view of the main game play screen of FIG. 11 during the same game round;

FIG. 14 shows a still further view of the main game play screen of FIG. 11 at the end of the same game round;

FIG. 15 shows the bonus screen of the interactive computer game of FIG. 1;

FIG. 16 shows the achievement screen of the interactive computer game of FIG. 1;

FIG. 17 shows the goals screen of the interactive computer game of FIG. 1; and

FIG. 18 shows the final score screen of the interactive computer game of FIG. 1.

### DETAILED DESCRIPTION

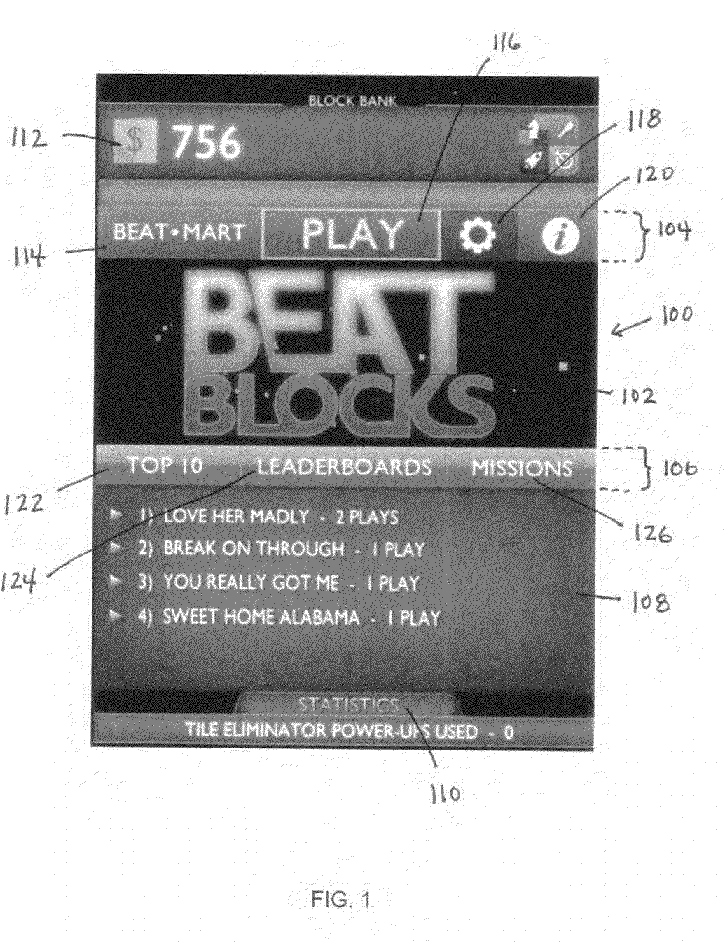

Referring to FIG. 1, there is illustrated the main menu screen of an interactive computer game system having music-derived variable parameters implemented on a mobile device according to one embodiment of the invention. In the illustrated embodiment, the game system is implemented on an Apple® iPad tablet device using the Apple® iOS operating system; however, in other embodiments, the game system may be implemented on computers, tablets, smartphones and/or other mobile devices using operating systems including, but not limited to, Apple® iOS, Google® Android and Microsoft® Windows and/or game consoles including, but not limited to, the Microsoft® Xbox, Sony® PlayStation and Nintendo® Wii. In the illustrated embodiment, the name of the game system is named “BEAT BLOCKS”, and the underlying game form is a tile-matching puzzle game; however, in other embodiments, the name of the game system and/or the underlying game form may be different.

The computer, tablet computer, smartphone, other mobile device or console (not shown) on which the game system may be implemented may include a processor, a display operatively connected to the processor, an audio speaker operatively connected to the processor, an input device operatively connected to the processor, a memory operatively connected to the processor and a communication device (e.g., Ethernet circuitry, Wi-Fi circuitry, Bluetooth® circuitry, etc.) operatively connected to the processor. The construction of such devices and connection of their component parts may be conventional to the extent not otherwise described.

Regardless of the underlying game form, the game system of the current invention involves the inclusion of one or more music-derived variable parameters in the game play and game experience. A music-derived variable parameter may be any parameter that is an inherent characteristic found in a plurality of specific music pieces in a music collection (or “music library”). In other words, the same parameter must be present in each music piece in the music library, although the specific value of the parameter may be different for each music piece in the library. Examples of such parameters include, but are not limited to, the overall time length of a music piece (typically given in minutes and seconds), the beat rate within the music piece (i.e., typically given in beats per minute), the pitch/frequency within the music piece (i.e., typically given in Hz), the volume within the music piece (i.e., typically given in decibels dB). In some embodiments, the values of the music-derived parameters may be predetermined for each piece of music in the music library, and then stored as machine-retrievable data values, while in other embodiments, the values of the parameters will be determined through real-time analysis of the music piece following its selection by the user in the game (as further described below).

In preferred embodiments of the invention, the game system facilitates the user's access to a library of stored music. The stored musical pieces are typically recordings of songs or other discrete performances (referred to as “tracks”) of the type often stored by means of digital encoding in formats including, but not limited, MPEG3 (MP3), AAC and audio-CD. In some embodiments, the music library used by the game system may be provided as part of the game system software itself. In other embodiments, the music library may be the user's personal library stored on the same mobile device as the game system and/or stored on a remote network, including so-called “cloud-computing” storage. In still other embodiments, the music library may be another person's music library or a pubic music library to which the user has access.

In a preferred embodiment of the game system, prior to each round of game play (i.e., of the underlying game), the user selects a musical track from those available in the game system-accessible music library. The game system then obtains the value of the one or more music-derived parameters from the selected music track. The game system then modifies the baseline rules and/or environment of the underlying game according to the value(s) of the music-derived parameter(s) from the selected music track. The game system then initiates the round of the underlying game using the modified rules and/or modified play environment. The user's experience of game play is thus uniquely customized to reflect the values of the music-derived parameters in the selected music track. Subsequently selecting a different music track will result in new rules and/or environment for a subsequent game round, whereas re-using the same music track will result in the same rules and/or environment in a subsequent game round.

In the Beat Blocks embodiment of the current game system, the underlying game form is a tile-matching puzzle game. The normal (i.e., baseline) game play of the underlying game is as follows: A plurality of game tiles are arrayed in rows and columns on a play grid. The game tiles include standard tiles and may also include special tiles. Each standard tile has an attribute, e.g., color, shape, markings, etc., that allows it to be categorized as “like” (i.e., materially identical) or “unlike” (i.e., materially different) adjacent standard tiles. The objective of the game is to swap (i.e., horizontally or vertically) one tile with an adjacent tile to form a horizontal or vertical chain of three or more like tiles. Bonus points may be awarded when a chain of more than three identical tiles is formed when two lines of identical tiles are formed in one swap. When chains are formed, the associated tiles disappear, and other tiles then “fall” (i.e., move down the screen) from the top of the screen to fill in gaps. Sometimes chain reactions (i.e., “cascades”) are triggered, where new tile chains are formed by the falling tiles. Cascades may be awarded with bonus points. One or more types of special tiles may be provided in the game system. The special tiles may operate according to unique rules for forming chains and/or awarding bonus points when used.

As further described below, prior to each round of game play, the Beat Blocks embodiment of the game system requires the user to select a musical track from those available in the game system-accessible music library. The game system then obtains the value of the one or more music-derived parameters from the selected music track. In the illustrated Beat Blocks embodiment, one of the music-derived parameters is the track length (time). The game system determines the value of the track length of the selected music track and then modifies (i.e., customizes) the length of the upcoming game round based on the determined value. In the current embodiment, the customized game round length is set to current track length value+one second. Thus, regardless of the music track selected, the associated game round will continue until the music track is completed, but not beyond. I.e., the song will not be “cut short” and there will be no “dead air” after the song ends. The game system then implements the game round for the customized game round length and uses the selected music track as the background music during that game round.

The illustrated Beat Blocks embodiment of the game system also utilizes a second music-derived parameter from the selected music track, namely the beat rate (beats per minute). As the song track plays during the game, the game system determines the current beat rate value and then customizes one or more visual characteristics of the game elements based on the determined value. In the current embodiment, the visual characteristic is the brightness of at least some of the standard tiles. Changing the brightness of the tile causes them to “pulse” (i.e., get brighter and darker) at the same beat rate as the current song value. This causes the tiles to pulse “in time” with the music. Thus, regardless of the music track selected, the pulse rate of the game tiles (or at least some of the game tiles) in the associated game round will be selected so that the tiles appear to pulse with the music beat. The game system implements the pulsing at the customized beat rate as the selected music track plays as the background music during that game round. It will be appreciated that the beat rate determination may be made by various known methods, and that real-time evaluation of the music beat is contemplated as one implementation of the determining the value of the beat rate.

Referring still to FIG. 1, there is shown the main menu screen 100 including a title area 102, an upper selection bar 104, a lower selection bar 106, lower information display area 108, a statistics button 110 and a bank area 112. The upper selection bar 104 includes a store button 114, PLAY button 116, settings button 118 and an information button 120. The lower selection bar 106 includes a history button 122, leaderboard button 124 and a missions button 126. Activating one of the buttons 122, 124 and 126 will cause the associated information to display in the lower information display area 108.

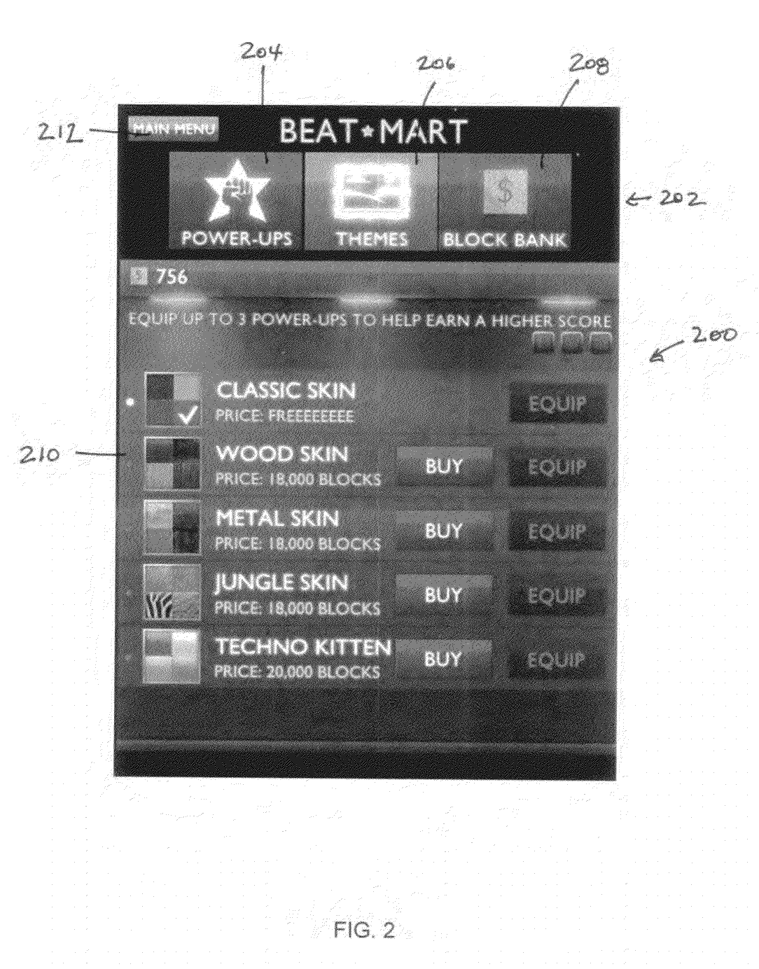

Referring now to FIG. 2, activating the store button 114 on the main display screen 100 changes the display to a store screen 200. The store screen 200 includes a mode selector 202 including Power Ups button 204, Themes button 206 and Credits button 208. Activating one of the buttons 204, 206 and 208 will cause the associated information to display in the lower information display area 210. This information may refer to products and/or services available for in-app purchase. Activating a main menu button 212 changes the display back to the main menu screen 100.

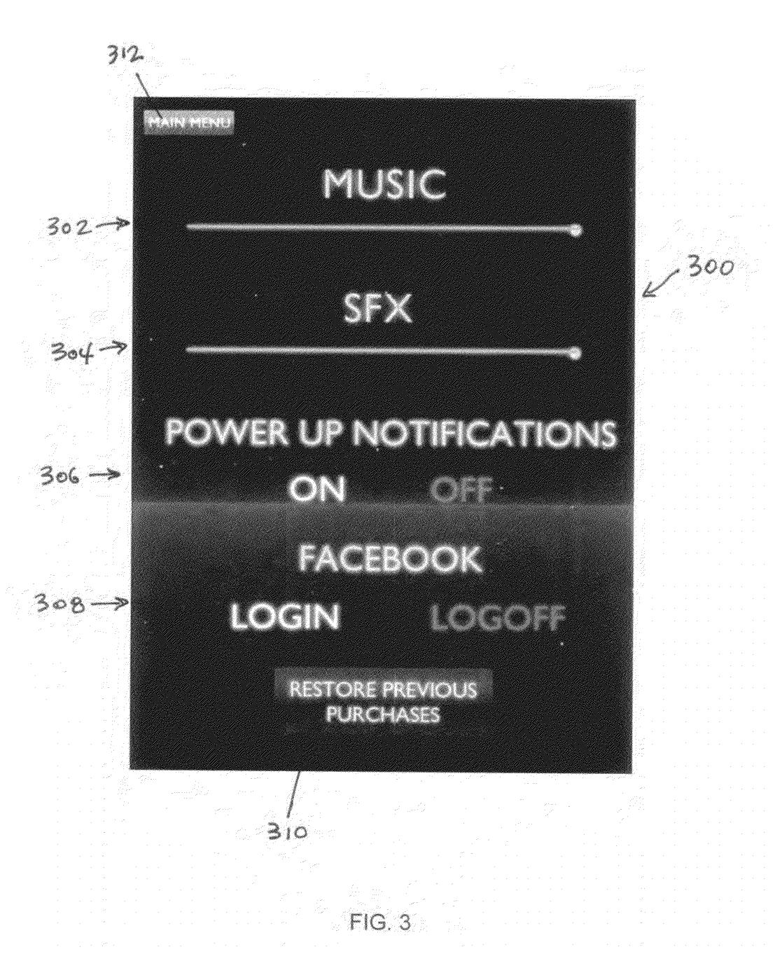

Referring now to FIG. 3, activating the settings button 118 on the main display screen 100 changes the display to a settings screen 300. The settings screen 300 includes a music volume slider 302, sound effects (“SFX”) volume slider 304, notification settings 306, third-party (e.g., Facebook) account login area 308 and a restore purchases selector 310. Activating a main menu button 312 changes the display back to the main menu screen 100.

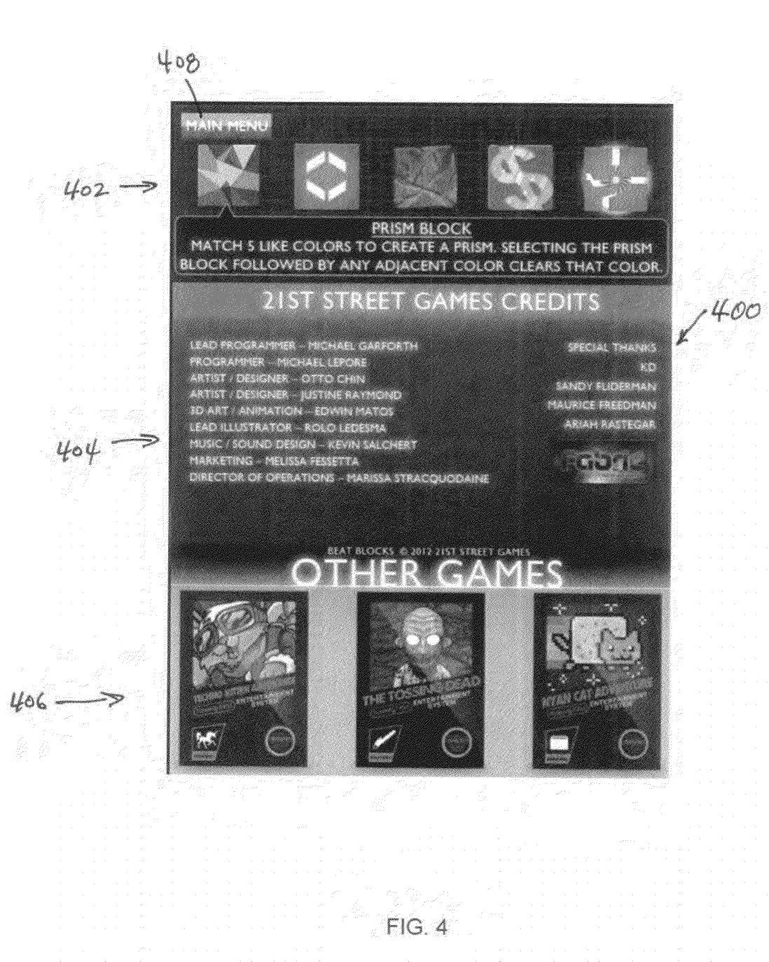

Referring now to FIG. 4, activating the settings button 120 on the main display screen 100 changes the display to an information screen 400. The information screen 400 includes a game description section 402 providing information regarding elements of the game. In the illustrated embodiment, information regarding the rules for special tiles are provided. A credits section 404 provides information regarding the developers of the game and an advertising section 406 provides information regarding other games, products and/or services of possible interest to the user. Activating a main menu button 408 changes the display back to the main menu screen 100.

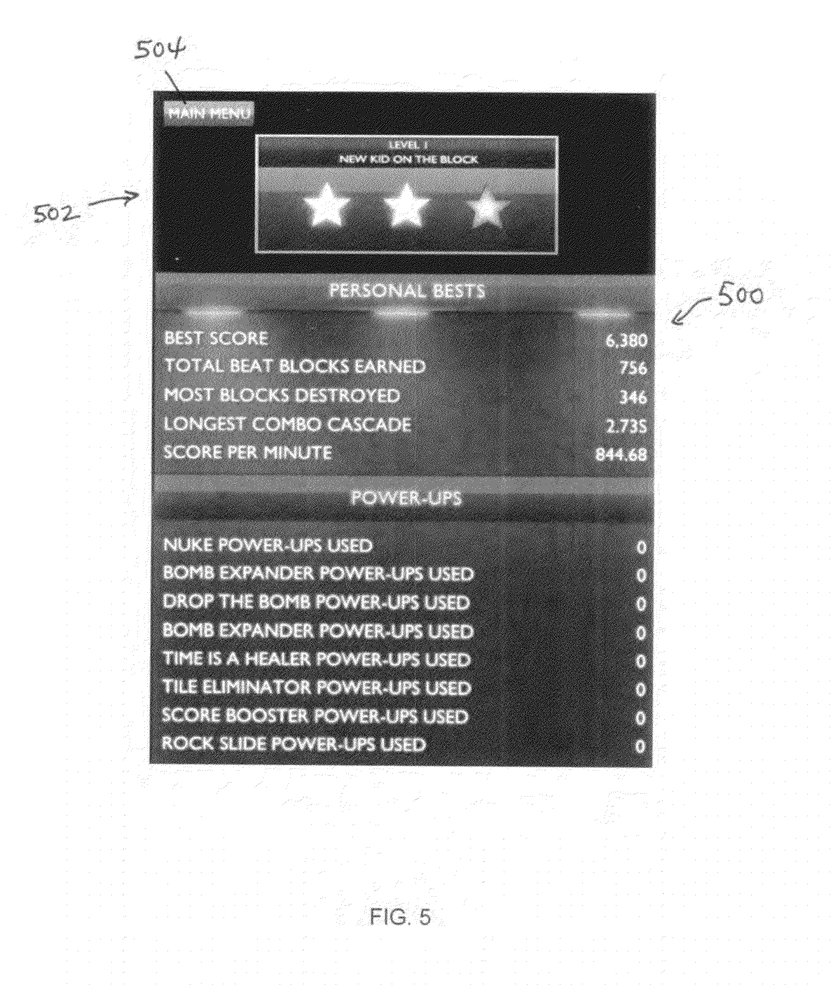

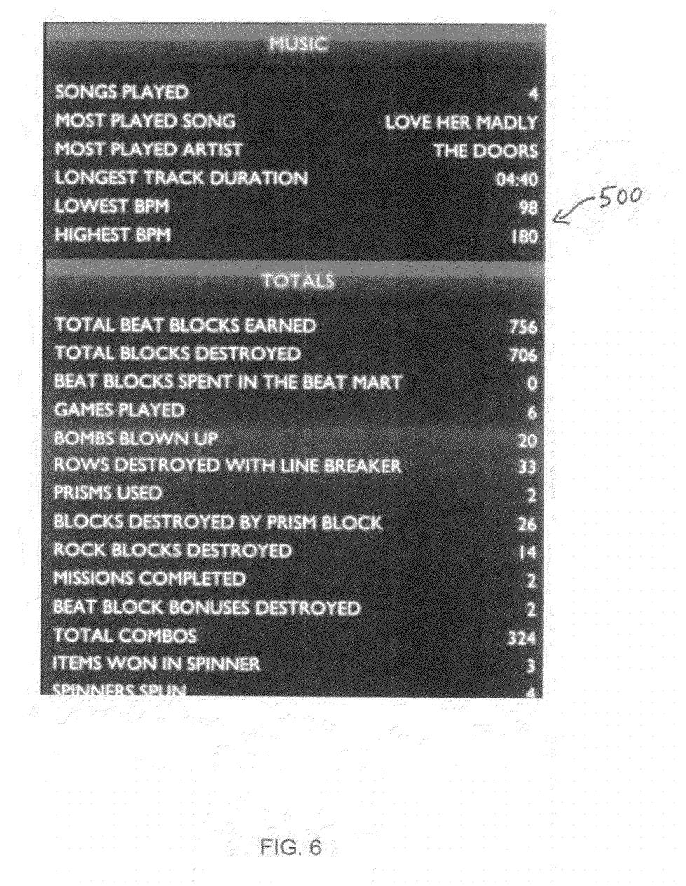

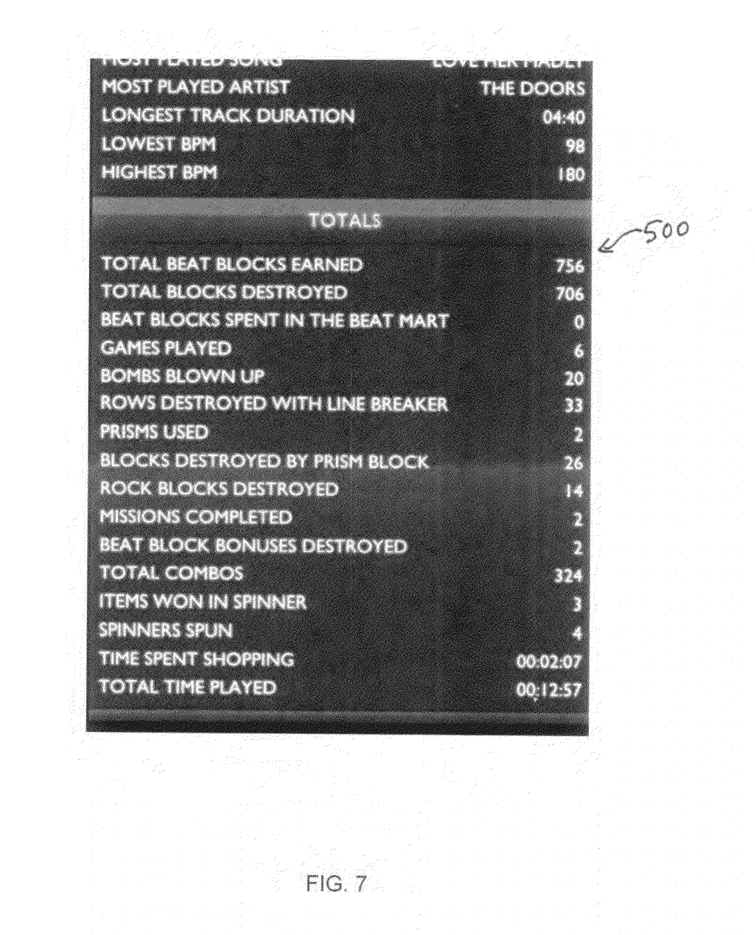

Referring now to FIGS. 5, 6 and 7, activating the statistics button 110 on the main display screen 100 changes the display to a statistics screen 500. The statistics screen 500 provides various information regarding scores, achievements, music listening habits and other information of interest to the user. An achievement level indicator 502 may be provided. Activating a main menu button 504 changes the display back to the main menu screen 100.

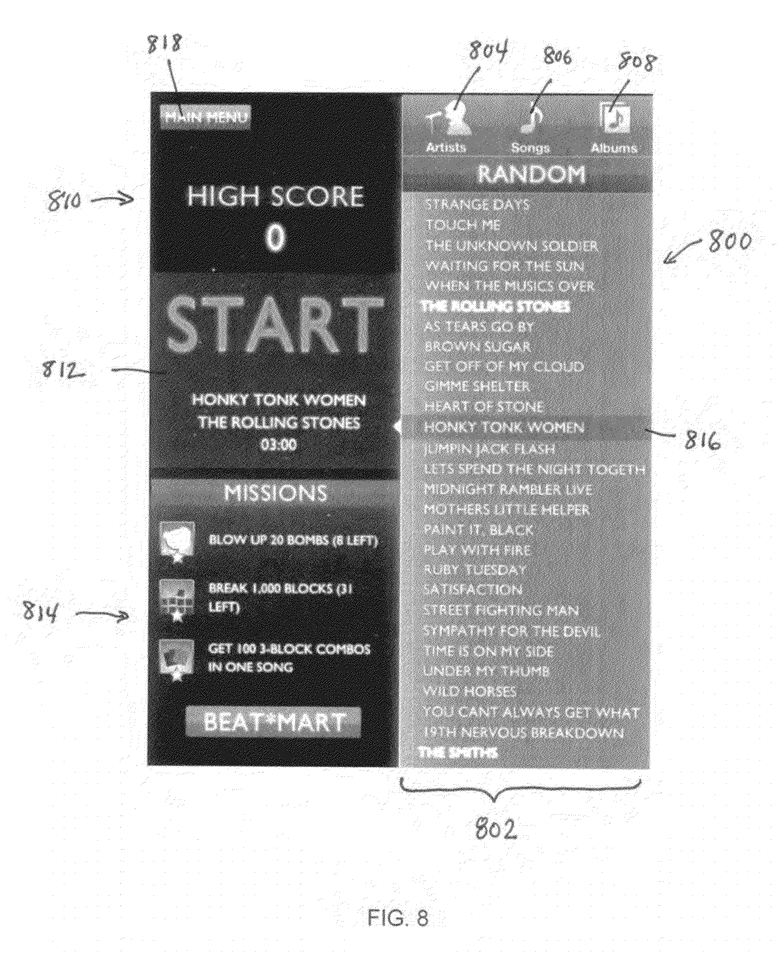

Referring now to FIG. 8 activating the PLAY button 116 on the main display screen 100 changes the display to a music selection screen 800. The music selection screen includes a music selection area 802, mode selection buttons 804, 806 and 808, a high score section 810, START button 812 and missions indicator 814. The music library available to the game system is listed in the music selection area 802, organized by artist, song or album, respectively, based on activation of buttons 804, 806 and 808. A selection bar 816 shows what music track is currently selected, and information regarding the track (e.g., track time length) is shown in the area of the START button 812. Activating the START button 812 will initiate a game round that is customized according to the values of the music-derived parameters in the selected music track 816. Activating a main menu button 818 changes the display back to the main menu screen 100.

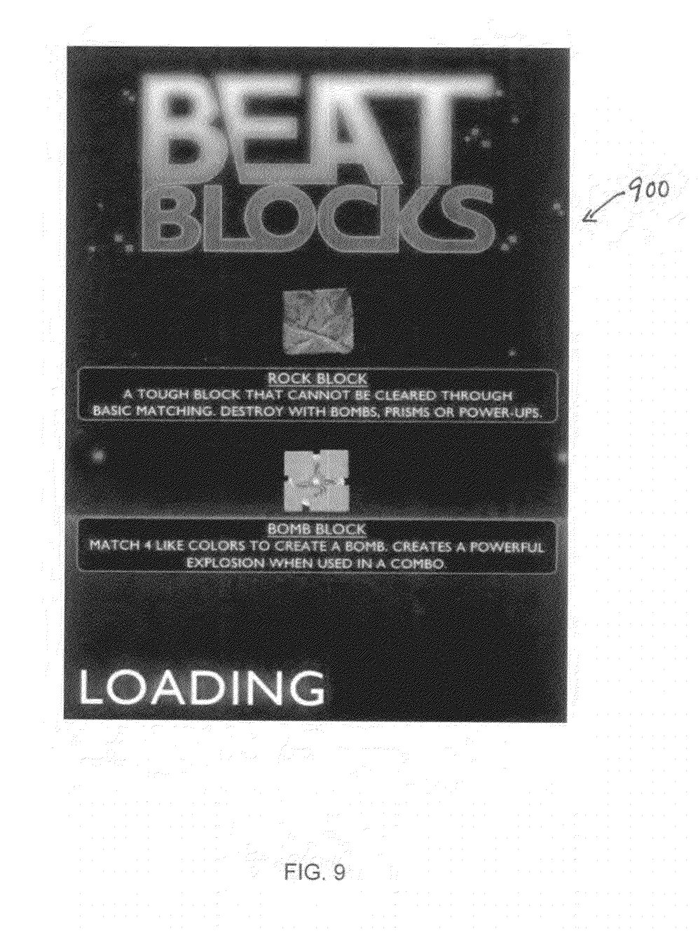

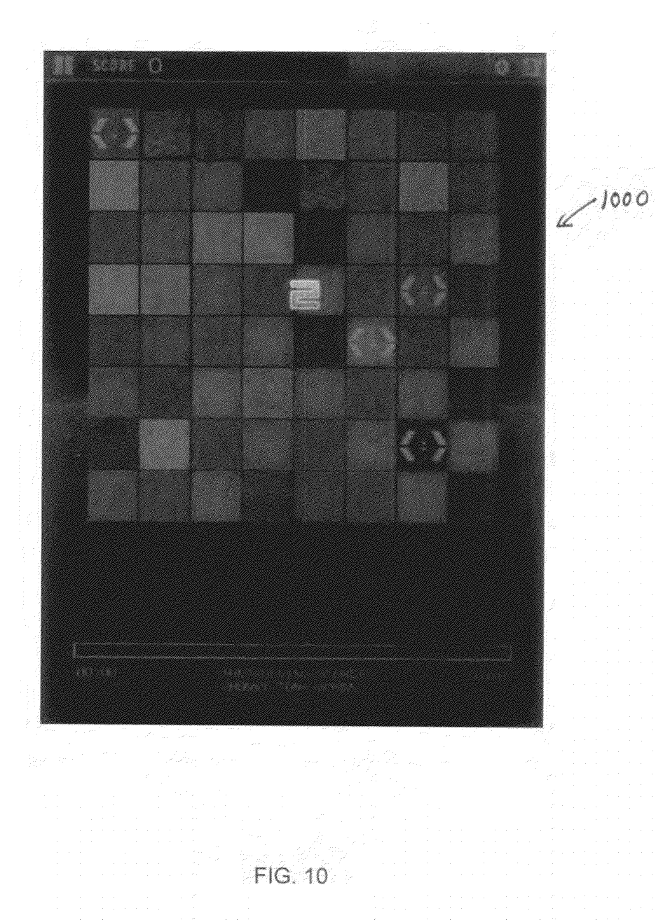

Referring now to FIGS. 9 and 10, activating the START button 812 changes the display to a LOADING screen 900 (FIG. 9), which may display game tips while preparing/loading the next game round. At the end of the loading sequence, a game board screen 1000 (FIG. 10) is previewed and a countdown “3-2-1” is displayed.

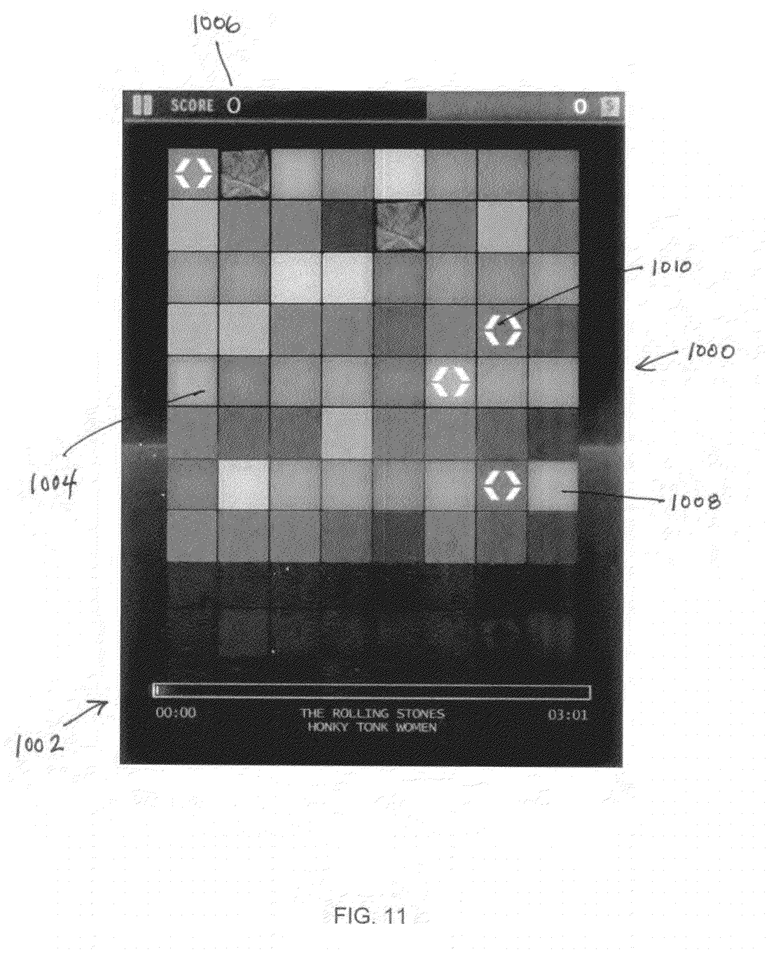

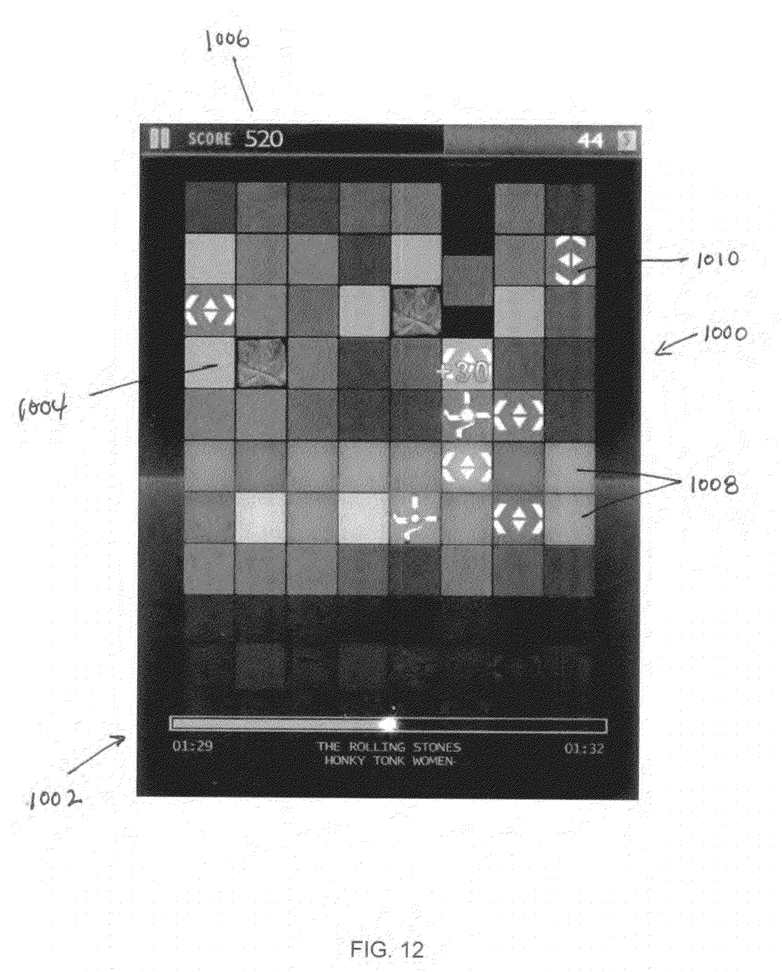

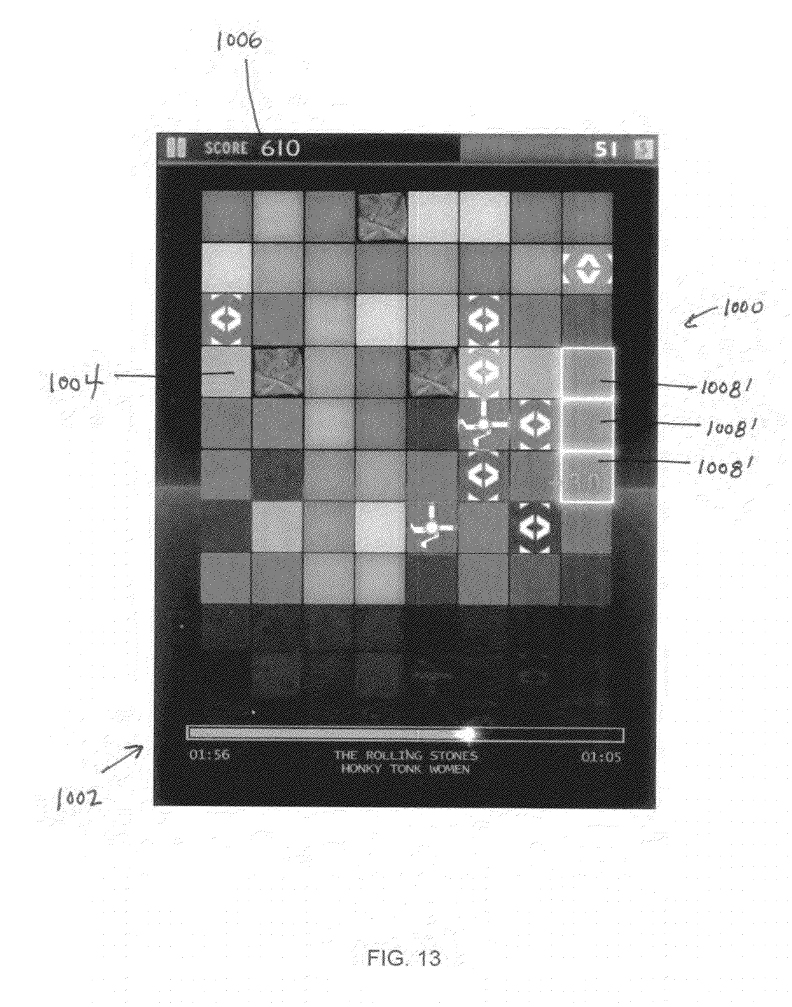

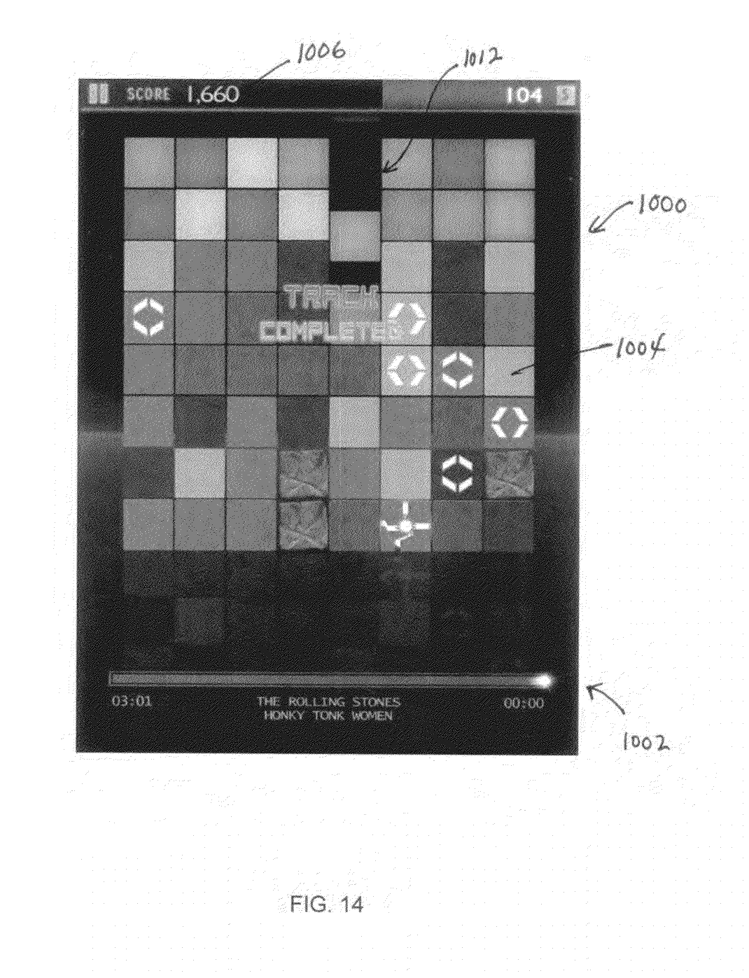

Referring now to FIGS. 11-14, after the countdown, the game board screen 1000 is fully revealed, the selected music track begins to play as indicated in music bar 1002, and game play can begin in the play area 1004 according to the rules of the underlying game. Note that the music bar 1002 includes a progress bar that indicates elapsed game round time on the left and remaining game round time on the right. Due to the customization of the game system, this indicated game round time is substantially the same as the elapsed/remaining time for the music track. FIG. 11 illustrates the game board screen 1000 at the beginning of the game round, FIGS. 12 and 13 illustrate subsequent views of screen 1000 during the round, and FIG. 14 shows the game screen 1000 at the end of the round. A score area 1006 indicates the current score and number of blocks (i.e., tiles) eliminated in this round. In the illustrated embodiment, both standard tiles 1008 and special tiles 1010 are included in the game. As best seen in FIG. 13, a chain of three adjacent identical standard tiles (denoted 1008′) produces a score. As best seen in FIG. 14, the chain subsequently “disappears,” leaving a gap 1012 in the game area that is filled with new tiles falling from the top of the screen.

Further, as best seen by comparing the views of FIGS. 11-14, the brightness of the individual game tiles (or at least some of the game tiles) pulses in accordance with the beats rate of the selected music track. This changes the game environment, and hence the user experience, for each game round based on a second music-derived parameter.

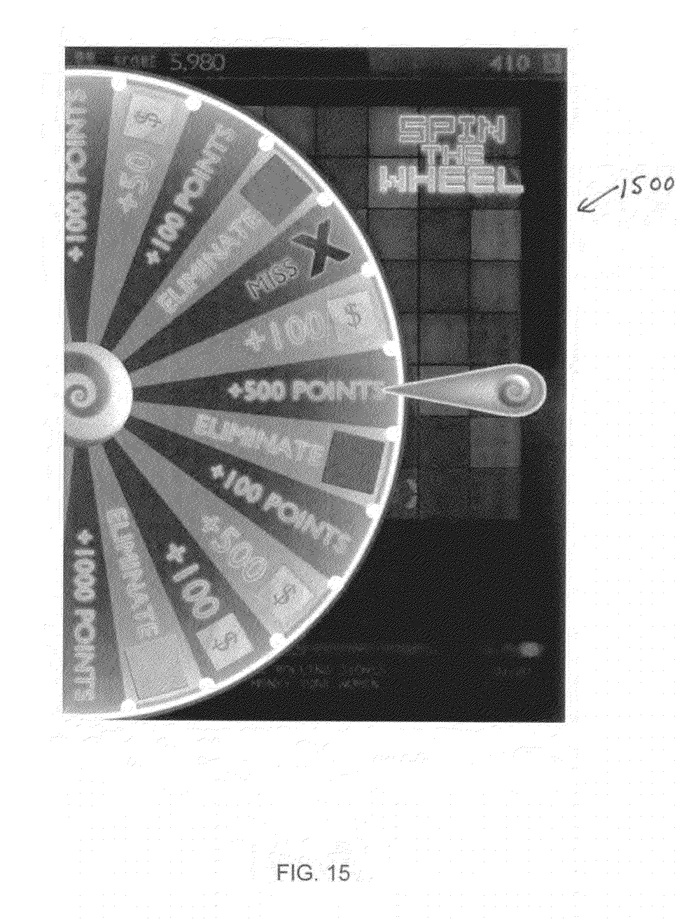

Referring now to FIG. 15, after the end of the round, a bonus screen 1500 may be provided, allowing the user to obtain extra points and/or credits. In the illustrated embodiment, the bonus screen includes a “wheel of fortune” spinner; however, other bonus motifs may be used. After the bonus is applied to the user's score, the system proceeds to the final screens.

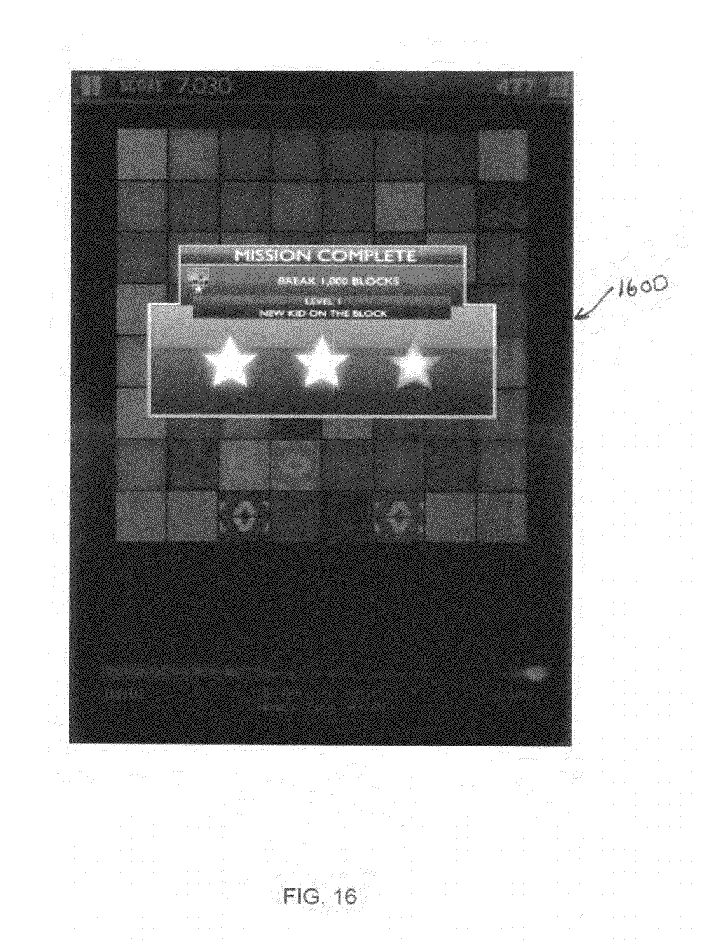

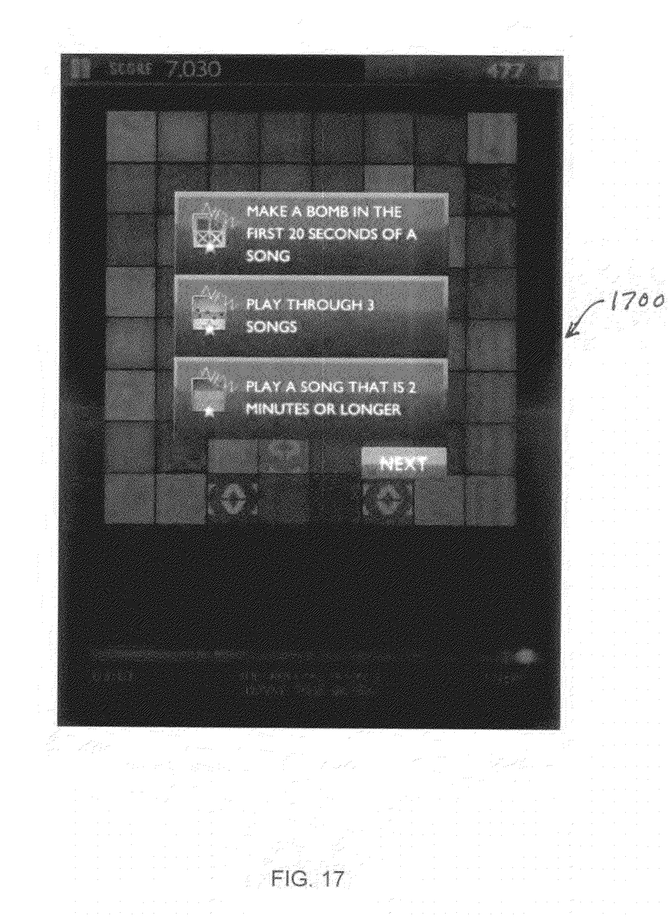

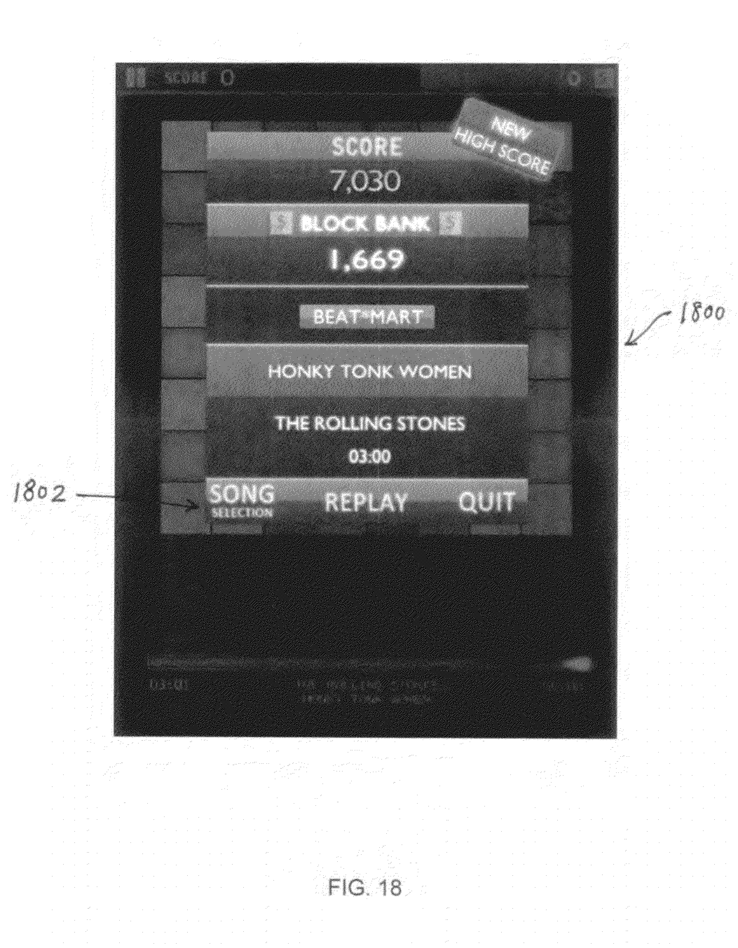

Referring now to FIGS. 16-18, there are illustrated, respectively, an achievement screen 1600, a new goals screen 1700 and a final score screen 1800. Activating a menu bar 1802 on the final score screen 1800 allows the user to return to the song selection screen 800, replay the current (i.e., just finished) game or quit the program.

Although the preferred embodiment has been described in detail, it should be understood that various changes, substitutions and alterations can be made therein without departing from the spirit and scope of the invention as defined by the appended claims.

What is claimed is:

1. A game system for implementing a computer game on a computer, a tablet computer, a smartphone, another mobile device and/or a console having a processor, a display operatively connected to the processor, an audio speaker operatively connected to the processor, an input device operatively connected to the processor, a memory operatively connected to the processor and a communication device operatively connected to the processor, the computer game having a round-based play system and a baseline set of rules, the game system comprising:
providing, using a processor, a user with access to a music library in a memory operatively connected to the processor, the music library including a plurality of musical pieces, each musical piece including at least one music-derived parameter;
prompting, using a display operatively connected to the processor, the user to select a specific one of the plurality of musical pieces using an input device operatively connected to the processor;
determining, using the processor, a value of a first music-derived parameter for the selected musical piece;
modifying, using the processor, a first baseline rule of a computer game in the memory, the modification being based upon the determined value of the first music-derived parameter; and
initiating, using the processor, a game round of the computer game in the memory using the first modified baseline rule of the game and playing the selected music piece during the game round using an audio speaker operatively connected to the processor.

2. A game system in accordance with claim 1, wherein the first baseline rule is a time duration value of a game round and the first music-derived parameter is a time duration value of the selected music piece.

3. A game system in accordance with claim 1, wherein the first baseline rule is a brightness value of a game tile displayed on the display and the first music-derived parameter is a beat rate value of the selected music piece.

4. A game system in accordance with claim 1, wherein the game system further comprises:
determining, using the processor, a value of a second music-derived parameter for the selected musical piece;
modifying, using the processor, a second baseline rule of the computer game in the memory, the modification being based upon the determined value of the second music-derived parameter; and
performing, using the processor, the game round of the computer game in the memory using the second modified baseline rule of the game.

5. A game system in accordance with claim 4, wherein the second baseline rule is a brightness value of a game tile displayed on the display and the second music-derived parameter is an audio frequency value of the selected music piece.

6. A game system in accordance with claim 4, wherein the second baseline rule is a brightness value of a game tile displayed on the display and the second music-derived parameter is an audio volume value of the selected music piece.

7. A game system in accordance with claim 1, wherein the game system further comprises:
downloading, using a communication device operatively connected to the processor, a music library from a remote location; and
storing the music library in the memory.
